(19) United States
(12) Patent Application Publication
(10) Pub. No.: US 2020/0294349 A1
(43) Pub. Date: Sep. 17, 2020

(54) RANDOM NUMBER SEQUENCE AND METHODOLOGY

(71) Applicant: Johannes A ROMBOUTS, Sydney (AU)

(72) Inventor: Johannes A ROMBOUTS, Sydney (AU)

(21) Appl. No.: 16/890,409

(22) Filed: Jun. 2, 2020

Related U.S. Application Data
(63) Continuation of application No. 16/786,106, filed on Feb. 10, 2020, now abandoned.

(30) Foreign Application Priority Data
Feb. 11, 2019 (AU) 2019900421
Feb. 3, 2020 (AU) 2020/200755

(51) Int. Cl. G07F 17/32; G07C 15/00

(52) U.S. Cl. CPC G07F 17/329; G07C 15/006

(57) ABSTRACT

A concert of twin identical barrel devices, able to produce a desired random number outcome sequence, within the field of stand-alone random number events. Each device is a transparent ball shaped enclosure, each holding an identical set of sequentially numbered lightweight balls. Each set is levitated and agitated only for a short period of time by air forced into the devices. Ceasing the forced air, said balls are allowed to come to rest. A process of randomly extracting a predetermined number of balls is then undertaken. From the identical barrels, preferably, only three balls are randomly extracted from each device. Three marked balls from a first barrel are combined with three marked balls from a second barrel, together producing a six random numbers, event outcome. As per the intention, said outcome may be comprised of three pairs, two pairs and two single, one pair and four singles, or, six singles.

### FIELD OF THE INVENTION RANDOM NUMBER SEQUENCING

The present invention relates to the generation of random numbers and random number sequences, with such numbers generated both individually and sequentially, by a genre of devices specific to the production of a stand-alone outcome or result. Accepted applications of a random number generator are for use in creating encrypted passwords, mathematical algorithms, engineering research, parapsychology, security codes, predictive text, broader physics and mathematical computation.

### BACKGROUND OF THE INVENTION

It is the object of the present invention to ameliorate an historic random numbers genre discrepancy by employing an improved and novel physical methodology, to produce a unique event result outcome.

In applications applied to competitive sports, lottery and lotto style stand-alone event outcomes, the methodology used in these iterations, are a simple true hardware version of random number generating. In this instance, involving a predetermined limited group or set of numbers, only as near to an absolute level of randomness is acceptable and expected. Simple iterations have existed for centuries, and currently exist in a number of forms throughout the world. Some recent history versions of these random number generators include totaliser wagering and the roulette wheel, employing indicia such as numbers, card suites or even fruit symbols. Examples of other public modern iterations are those commonly known as Bingo and Lotto.

In these particular types of random numbers iterations, individual player participants employing an uncomplicated simple application of probability, may select a group of indicia or numbers either manually on a printed entry form, or by a random number integrated electronic device generated selection of indicia from a sponsor at the point of purchase, to be matched against a plurality of numbers, drawn and decided randomly at a later time, by the affiliated sponsor. Generally an official hard copy printed ticket bearing on it a selection of chosen or generated indicia, confirms participation and event entry.

The modern form of an event in this field commonly involves extracting, one at a time, a set of numbered balls from a hardware clear barrel or sphere. This visibility is intended to assure the selection produces an unpredictable non biased random selection and outcome. Once drawn and displayed, the common methodology dictates the ball is not returned to the barrel during the course of the event.

The intent is to produce a random one-off sequence. Each wholly completed sequence ‘draw’ is a single stand-alone event.

A legitimate claim to a reward depends solely on an exact plurality between the drawn indicia and the validated selection of the participant.

### PRIOR ART

IP Data Base: UK/Europe. Australia. Japan
Found: Nil current or historic.
USA patent office Data Base.
(current status unknown)
U.S. Pat. No. 4,984,796 Peacock 1991
U.S. Pat. No. 4,796,890 Snyder 1989
U.S. Pat. No. 4,444,394 Pasquine 1984
U.S. Pat. No. 4,373,728 Korzenietz 1983
U.S. Pat. No. 3,304,091 Bittner 1961
U.S. Pat. No. 2,103,151 Deitrich 1937

### 497726 Phelps 1893

### BRIEF DESCRIPTION OF THE INVENTION AND EMBODIMENTS

It is the object of the present invention to provide an improvement and solution, to ameliorate a random numbers genre discrepancy and omission in this field, by creating a completely new methodology embodiment, producing, as a direct consequence, a numerical sequence outcome unique to the invention and intent. The present invention relates to a new physical methodology of random number generation; such numbers generated, either individually or sequentially, by either a single or multiple devices, specific to the field, and specific to the production of a stand-alone random outcome event result.

In the preferred form there is provided a device, or multiple identical devices, working in tandem concert.

Said devices, commonly comprised of a round ball shaped transparent clear enclosure, and referred to as a ‘barrel’ in the related field, also holds within its confines, a number of lightweight spheres, commonly referred to as ‘balls’. A predetermined number of ball spheres, with each such ball bearing on its surface, one number in and of, an increasing sequence, are individually selected randomly by a form of electro mechanically engineered extraction recognised in the field. The general device shape and mechanics are not specific to the invention, however, utilising such devices and their functions as a whole, are in themselves, considered an integral physical aspect in producing the invention and intent.

Comprising, accordingly, such devices are employed in an identical tandem concert with a dual, and duplicated balls, identical sequences methodology, so as to enable the physical production of a desired random numbers numerical sequence unique to the invention. As such, the collaboration of these identical elements improves upon, and sets itself apart from all current field applications, methodologies and known sequence results. It will be understood by persons skilled in the art of this genre, the invention methodology is a novel application creating a solution and embodiment unlike anything currently existing in the field.

The invention is a solution to a completely overlooked and historically missed iteration within this field genre. Specific to the field, the invention iteration creates a specific random number outcome sequence that comprises and includes a pair or pairs of and from the baseline integers or indicia in use.

The common iterations in this field involve a set of balls, which could be individually sequentially numbered from 1 to 40 to as high as 1 to 90, from which a plurality of balls are drawn to give a random final event result numerical sequence.

Alternatively, that particular numbers sequence is only the first part of a result that requires just one other single ball drawn from a second barrel holding a greatly reduced number of balls. This extracted single ball is commonly referred to in the field vernacular in this genre iteration, as a ‘powerball’. These particular stand-alone events produce an intended, separated, 6 or 7 sequence plus one other separate integer, in a divided two part outcome.

In a co-dependent relationship of two identical physical elements, improving upon the above described existing iterations and methodology, the invention's expressed novel difference sets it apart in this field.

The preferred novel embodiment and expressed form of this invention, is comprised of, but not limited to, two clear, identical twin barrel devices, working in tandem concert. Further, each such barrel, separately, employs a duplicate, or identical, marked, sequential numbered set of ball spheres, with only one such set, held within a first device, to be employed in tandem with a second separate identical barrel device holding within it, an exact and identical duplicate of the first instance marked sequence ball set. With the described physical elements working together, extracting preferably only three balls from each barrel, the two separate numerical outcomes when combined together, will produce a whole single stand alone event outcome numerical sequence, unique to the genre and field. This combined whole sequence could, both physically and mathematically, include either, a pair, or pairs of, and from, the individual identical duplicate numbered ball set sequences. As such, the invention overcomes and resolves an historically overlooked gap and missed embodiment.

### Notes

1. The term “comprising” (and grammatical variations thereof) is used in this specification in the inclusive sense of “having” or “including”, and not in the exclusive sense of “consisting only of”.
2. The discussion of the prior art in the Background of the invention, is not an admission that any information discussed therein is citable prior art or part of the common general knowledge of persons skilled in the art in any country.

### BRIEF DESCRIPTION OF THE DRAWINGS

FIG. 1 is illustrative of a player participation/entry card where the displayed duplicate numbers are in two separate boxes laid out side by side, as shown.

FIG. 2 is illustrative of a player participation/entry card where the displayed duplicate numbers are laid out immediately adjacent to each other in one single larger box, as shown.

FIG. 3 is an illustrative example of a possible 3 pairs, randomly generated sequence outcome from the numbered balls.

FIG. 4 is illustrative of a first preferred physical embodiment and application, wherein two identical twin clear barrel devices, each containing a duplicate number of balls, are used in tandem as a sequence generating extraction process is undertaken.

FIG. 5 is illustrative of second physical embodiment variant and application, wherein a single barrel containing both duplicate numbered balls sequence sets are combined in just one barrel enclosure, as a sequence generating extraction process is undertaken.

FIG. 6 is illustrative of a third physical embodiment variant and application, wherein multiple identical clear barrel devices are used in tandem, each containing a single duplicate set of numbered balls, as a sequence generating process is undertaken.

### THE DRAWINGS

The accompanying drawings which are incorporated in and constitute integral parts of the specifications, illustrate the preferred embodiments, and, together with the worded description, serve to explain the elements and function of the invention.

### DETAILED DESCRIPTION OF THE DRAWINGS

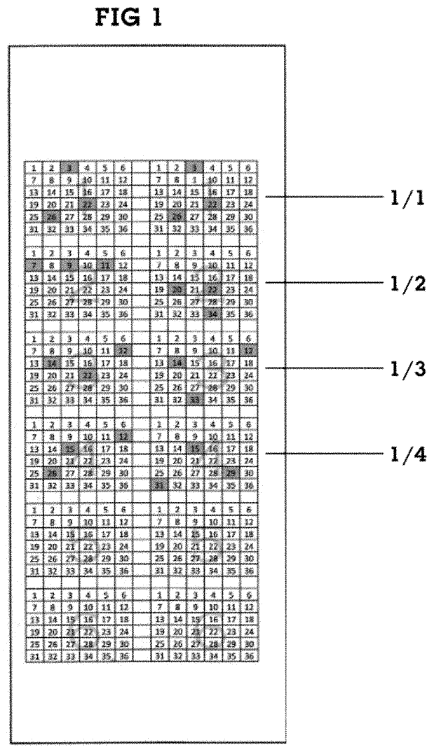

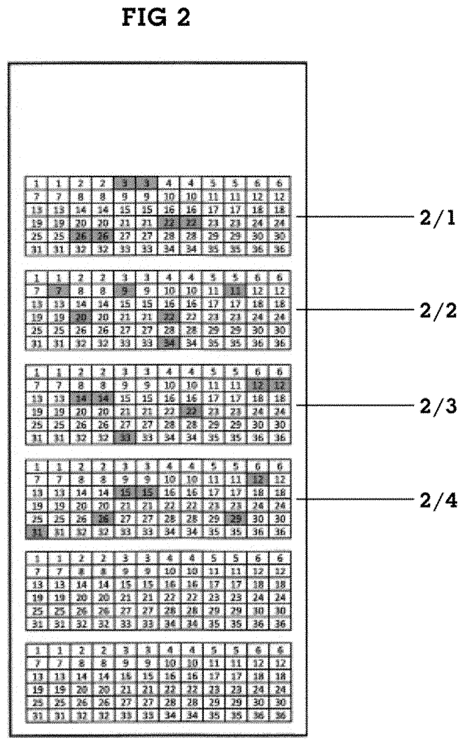

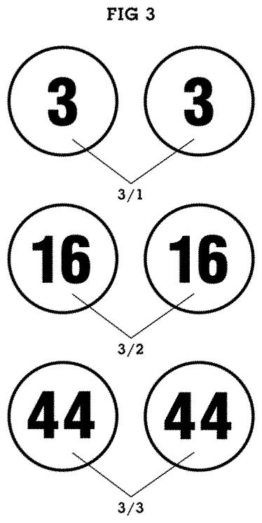

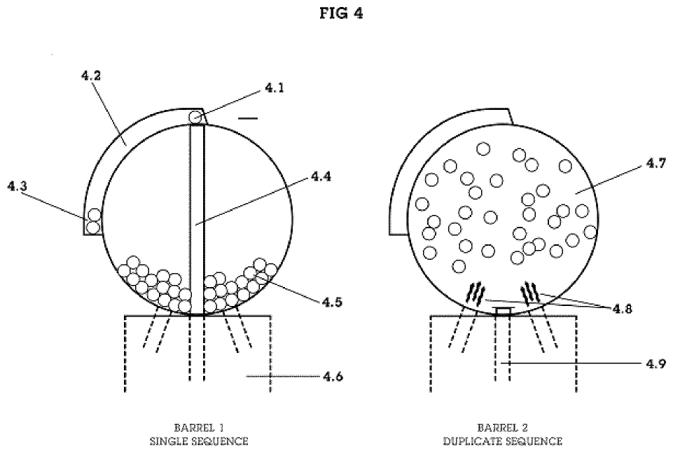

This invention, in its preferred variations, employing TWO of said transparent DEVICES in concert, (FIG. 4) encompasses a selection of THREE (3) GROUPS, or sequence sets, of IDENTICAL NUMBERS, or duplicate pairs, of any individual number as presented, per game event, (FIG. 3), (eg: 1/1,16/16,44/44 etc) up to and including 44/44, in that specific #3 variant. The final sequence outcome being determined by immediately following the first part event (FIG. 4 barrel 1) by a tandem separate identical event, using a separate identical device, (FIG. 4 barrel 2) with said device, by virtue of its elements and functions, able to produce the second and other part of a complete and final sequence outcome. By nature of the field of the invention, what is commonly referred to as a player entry card, and such allowing participation in the event, is by necessity, created to reflect the intention of the invention, with its four outcome configuration possibilities embodied in the specifics of the described variants, as illustrated in examples, FIG. 1 and FIG. 2. To that end:

FIG. 1: A player card displaying the 3 from 36 variation, and offering the choice of four different ways, iterations or possibilities, unique to the invention, to participate in a single event. Three pairs: (FIG. 1/1) Six singles: (FIG. 1/2) Two pairs and two singles: (FIG. 1/3) One pair and four singles: (FIG. 1/4). In one game card variation, (FIG. 1), said games seen laid out as two separate yet identical boxes set side by side, with each individual box numbered only from 1-36. (FIG. 1: 1/1)

FIG. 2: A player card variation, displaying a single box, totalling 72 numbers, (FIG. 2: 2/1) with each of the individual duplicate numbers, from 1-36, situated immediately and then sequentially adjacent to each other. Eg: 1/1.2/2.3/3 etc. (FIG. 2/1) Example card FIG. 2, also allows for the four options/ways previously described, to participate in a single event. (FIG. 2/1,2/2,2/3,2/4.)

FIG. 3: Illustrates the specific intention and possibility of a three pairs single event outcome, based on the number sequence employed, as previously described in variations #1, #2, #3. Or as exampled per: FIG. 1/1 and FIG. 2/1: 3/3, 22/22, 26/26.

FIG. 4: Twin barrel 1, illustrates the embodiments of the clear barrel methodology commonly used in the field. A captured ball, (4.1). A clear presentation tube to collect and display the captured balls, (4.2). A selection of visible captured balls, (4.3). A rising ball capturing and delivery pole, (4.4). A collection of static resting balls, (4.5). The black box electro-mechanics to enable a ball capture, (4.6). FIG. 4: Twin barrel 2. The air suspended balls moving freely in space, (4.7), commonly agitated by forced air, (4.8, 4.9), delivered by the black box electro mechanics, withholding a retracted ball capturing delivery pole, (4.6).

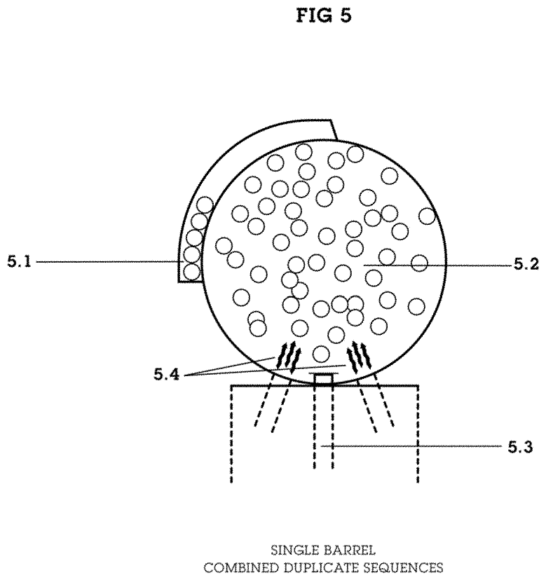

FIG. 5: illustrating an example of variation #4, having extracted some of a predetermined total set of balls (5.1), wherein both sets of identical duplicate balls (5.2) are held within a single barrel sphere, and commonly agitated in suspension by forced air (5.4) by the black box electro mechanics (5.3).

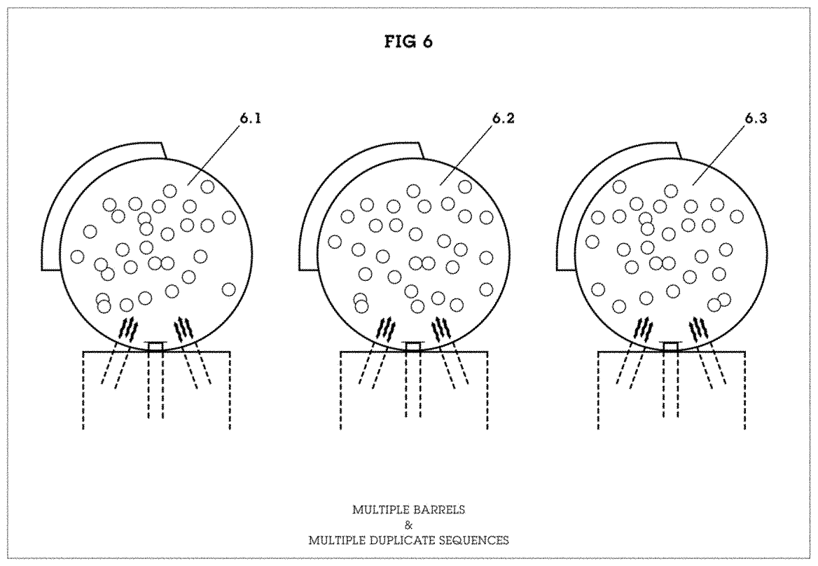

FIG. 6: illustrating an example of the possible variations available within the intention, which includes multiple identical clear barrel spheres (6.1. 6.2. 6.3) each containing an equal number of identically marked balls, to work in tandem to produce a single event outcome sequence specific to the intention.

### DETAILED DESCRIPTION OF THE INVENTION

There is described, a collaboration of identical elements, re-inventing existing current field applications, methodologies and known resultant sequence outcomes. It will be understood by persons skilled in the art, the invention methodology and intent resolves a completely overlooked and missed iteration embodiment within all current variants and methodology, able to produce a subsequent outcome unique to the existing field genre.

In the current related field, commonly, such devices are comprised of a round ball shaped transparent clear enclosure, and referred to as a ‘barrel’ in the related field, also holds within its confines, a predetermined number of lightweight spheres, commonly referred to as ‘balls’, with each such ball bearing on its surface, one number in and of, an increasing numerical sequence.

Subsequently, a small and limited predetermined number of ball spheres are individually and randomly extracted from the whole set of balls, by a process of electro mechanically engineered extraction, as recognised in the field. Each extracted individual numbered ball thereby becoming part of a final limited sequence outcome made up of only single numbers from the numerical sequence held within the single barrel.

The existing issue with such sequences is; they are always and only comprised of a one dimensional group of single numbers from the single numerical sequence held within the single barrel. The inventive solution resolves that, by creating a unique and novel double matrix identical duplicate iteration.

Accordingly, two barrel spheres are utilised in tandem, where, unlike every other field iteration, specifically, both barrels are identical to each other in every element, including an exact and identically marked sequence of numbered balls held within each barrel. Accordingly, a next and subsequent phase, is, the extraction of only three (3) balls from each barrel, these two separate parts combined, producing a single whole final sequence. None of the other existing genre iterations do, or are able to produce, a final outcome that can be made up of duplicate pairs of numbers, as here, of and from the predetermined identical numerical sequence held separately within the two identical barrels.

The preferred novel embodiment and expressed form of this invention, is comprised of, but not limited to, two clear, identical twin barrel devices, working in tandem concert. Further, each such barrel, separately, employs a duplicate, or identical, marked, sequential numbered set of ball spheres, with only one such set, held within a first device, to be employed in tandem with a second separate identical barrel device holding within it, an exact and identical duplicate of the first instance marked sequence ball set. With the described physical elements working together, after a short period of agitation, extracting only a limited specific number of balls from each barrel, the two separate numerical outcomes when combined together, will produce a whole singular stand alone event outcome numerical sequence, unique to the genre and field. This combined whole sequence overcoming the existing shortcoming, could, both physically and mathematically, include either, a pair, or pairs of, and from, the individual identical duplicate numbered ball set sequences.

Thereby, resolving the limiting broad based existing genre embodiments which only produce an individual single numbers sequence outcome.

As such, the collaboration of these identical elements improves upon, and also solves a discrepancy and omission problem, by setting itself apart from all current field applications, methodologies and known sequence results, by the applied duplication and identical element. This inventive duplication methodology, by its concert of elements, thereby, physically and mathematically, is able to create and produce a random sequence incorporating pairs, in the final result outcome.

In the background field of multi indicia random number outcome iterations, there is comprised: a first part, physical method novel to the known field of random number generation, in concert with an identical second physical method, so as to separately generate an equal first and second part to be combined as a single whole random numbers sequence, specific to the intent.

In the intent of the invention, there is a direct relationship methodology of two physical elements; a barrel device, and a duplicated set of sequentially marked balls.

There is comprised; identical twin barrels, each holding an exact number of identically numbered duplicate balls as the other, working in tandem, enabling the generation of a unique random single numerical sequence outcome, which, in an absolute mathematical probability, can be comprised of a pair, or pairs of, and from, the two duplicated numbers ball sequences.

The novel event outcome claimed herein, is produced by the symbiotic relationship of the combined elemental embodiments, comprised of (preferably) two identical twin barrels working in tandem, with each holding within its confines a sequentially numbered set of balls, a duplicate and identical to those within the other barrel. Said duplicate ball sets made up of, (preferably) just 36, 39, 44, or 48 numbered balls, within each identical but separate barrel. From any of these included duplicate variations, after a short period of agitation, only three numbered balls are randomly extracted from each barrel device, to be combined for a final six indicia outcome result.

As per the novel method, two separate sets of either 36, or 39, 44, or 48 balls, can produce any combination of pairs (FIG. 3) of, and from, these variations. The combined outcome sequence can be uniquely comprised of three pairs of, and from, the numbers of the identical ball sequences. The invention is the solution for a completely overlooked and historically missed iteration within this field genre.

The complete random event sequence outcome is determined by a physical methodology, with the first half part of the event, the random extraction of just three balls, from a first barrel, employed in tandem with a separate and second half part event, using the second but identical barrel device, with said barrel, by virtue of its elements and functions, as in the first, enabling the extraction of a random second set of three balls, thereby producing the other half part of a random six indicia sequence and single event, outcome. With the described embodiments and mechanics working together in tandem concert, the invention is able to produce a currently unrealised final random six number sequence, comprised of three pairs of, and from, the two identical numbers sequences. Equally, within the related physical and mathematical probability, there is also exists the absolute possibility of a final six number sequence comprised of, two pairs and two singles; one pair and four singles; or six singles; all as per the intent.

As a direct ancillary consequence, this duplicated identical twin sequences event, creates participation particular to the intent and novel in the field. An individual participant is now able to engage in a simple form of mathematical probability, in the stand-alone event, by employing a specifically related six number (entry card) combination, (FIG. 1, FIG. 2), encompassing either six single numbers, eg: 1/2/3/4/5/6), a pair with four single numbers, eg: (1/1/2/3/4/5), two pairs with two single numbers, eg: (1/1/2/2/3/4) or three pairs, eg: (1/1/2/2/3/3). In this instance, these probability choices are applied to the preferred ball set sequence numbers, being; the indicia variations examples of, either, twice 3 from 36 or twice 3 from 39, or twice 3 from 44, or twice 3 from 48, but certainly not limited to these particular indicia sequences.

Also specific to the preferred variations, is the mathematics and related odds of the described invention; the preferred tandem concert of two identical twin barrel devices, with three marked balls drawn out from within each, as one part of the whole two part configuration, produces, from one preferred variation, (eg): the 1-36 variation, mathematical odds unique to the described event outcome, of, 50,979,600 to 1. By employing six (6) numbers from a two (2) set total of seventy two (72), said odds are mathematically produced as follows; 3 from 36=12. 2 from 35=17.5. 1 from 34=34.

The three results are multiplied together. 12×17.5×34=7140. Multiplied by the same outcome of the second barrel, being 7140×7140=50,979,600 as stated.

In a second preferred duplication variation, 1-39, with three marked balls drawn from each barrel, produces field and mathematical odds unique to the described event outcome, of, 83,521,321 to 1, by combining six (6) numbers from a two (2) set total of seventy eight (78). IE: 3 from 39 multiplied by 3 from 39.

In a third preferred variation, but not limited to, 1-44, with three marked balls drawn from each barrel, produces field and mathematically acceptable odds unique to the described event outcome, of, 175,244,644 to 1, by combining six (6) numbers from the identical two (2) set total of eighty eight (88). IE: 3 from 44 multiplied by 3 from 44.

In a fourth preferred variation, but not limited to, 1-48, with three marked balls drawn from each barrel, produces field and mathematically acceptable odds unique to the described event outcome, of, 299,151,616 to 1, by combining six (6) numbers from the identical two (2) set total of ninety six (96). IE: 3 from 48 multiplied by 3 from 48.

This inherently creates another unique element of the described invention, being, the possibility of four different mathematical combinations to make up the six final numbers. Those being: three pairs, two pairs and two singles, one pair and four singles, or, six singles.

Accordingly, an embodiment variation within the scope and intention of the invention, allows for the employment of a SINGLE barrel, holding within, BOTH, identical duplicated BALL SEQUENCES being employed, (FIG. 5), allowing, in the described extraction manner, the selection of the preferred six numbers sequence, producing a random final sequence event outcome, which may be comprised of a pair or pairs of, and from, the combined duplicate ball sequences.

Comprising a second embodiment within the spirit of the intention, the single barrel iteration, (FIG. 5) employing all of both sets of the duplicate balls/spheres within it. Said barrel now holds, in this iteration variation, the two identical duplicates of the predetermined indicia ball sequence, preferably, being only, either, 1 to 36, twice: 72, or 1 to 39, twice: 78, or 1 to 44, twice: 88. The absolute possibility and probability of having a three pairs result of the marked numbers, remains. As does the other mathematical possibilities of two pairs and two singles, one pair and four singles, and six singles. The use of one or two supplementary numbers, drawn after the initial six numbers are drawn, is also still possible.

This particular single barrel iteration, in using the above mentioned ball sequence variations, each produces its own set of related mathematical odds. Those being: 156,238,908, 256,851,595, and 541,621,176, respectively. These odds being determined with the mathematical formula as described above, but relating specifically to a single part, single, in line, six number sequence. Player participation forms, as illustrated in the included drawings, FIG. 1 and FIG. 2, and individual player participation employing said forms, would not be affected with this single barrel, dual identical sequence, variation.

Other variations of the intention may include either more or less duplicate balls within a barrel, and/or, more or less identical barrels (FIG. 6) which may be used in tandem concert, as described, to generate the possible and probable pairs random sequence game event outcome.

In an accepted fashion within the genre, forced air may be introduced into the first barrel, sufficient to cause said balls to levitate, scramble and mix randomly and freely in three dimensional space within the barrel enclosure for at least a short period of time, so designed and intended to assure and increase the randomness and unpredictability of the game event outcome. Following which, the agitation air injection is ceased and all the balls now fall to the bottom of the barrel.

In the present invention, a first random single ball is then removed/extracted either manually, mechanically or by vacuum suction, captured and deposited to be visibly displayed outside the confines of the first barrel (FIG. 4.3) to allow the recognition of the random individual ball and its particular indicia/number. In the present invention, the procedure is then repeated twice more in the first barrel, to extract a preferred total of just three, (3) numbered, balls/spheres, these making up the first three indicia of a generated preferred random six number or indicia sequence.

At this point, a single ball, commonly referred to as supplementary number, may also be removed, if included as an ancillary part of the event result. This supplementary number is commonly employed only to allow participants an improved chance at a minor share of the reward pool.

The whole drawing procedure is undertaken in tandem concert, in full, with a second identical twin barrel holding exactly the same number of balls as the first, each of which is marked as identical duplicates of the first sequence set of balls, to produce the second part, (3) three, of the six (6) numbers, to make up the total desired outcome sequence, and, again, if included, a single second supplementary number may be drawn out at this point.

This tandem embodiment is comprised of two identical twin barrels each holding the same sequence of numbers, be they, preferred iteration/variant #1, 1 through to 36, or variant #2, 1 to 39, or variant #3 1 to 44, or variant #4, 1 to 48, now produces a unique element of the invention, being, the possibility and probability of a single pair, or two pairs, or three pairs of numbers, drawn and combined as part of the final outcome sequence. An example of such three pairs, in any of the three iterations, being: 3/3, 22/22, 26/26, (FIGS. 1 and 2) or 3/3, 16/16, 44/44, as illustrated in FIG. 3.

The unique possibility of four different mathematical combinations to make up the six final numbers of the outcome sequence has now been created. Those being: three pairs, two pairs and two singles, one pair and four singles, or, six singles.

The number of barrel enclosures, and numbered balls within said barrels, used within the present invention may be:

Preferably, but certainly not limited to, the number of said barrel enclosures is 1.

Preferably, but not limited to, the number of said identical barrel enclosures is 2.

Preferably, but certainly not limited to, the number of said lightweight ball spheres within a single barrel may be 88.

Preferably the number of said ball spheres in a single barrel is 48.

Preferably said numbers/indicia inscribed upon said balls, comprised of a consecutive numbers sequence, being, for example, 1 through to 48.

Preferably multiple lightweight balls, are lifted up and agitated by forced air, within, the barrel device, for a single event.

Preferably only one ball at a time, is randomly extracted to be included in an overall event final sequence.

Preferably only a total of three randomly extracted balls are removed, one by one, from a ‘first’ single barrel, to produce the first half part of a total six number/indicia event final sequence.

Preferably thereafter, only one ball may be randomly extracted from said ‘first’ single barrel, to produce the first of two supplementary numbers/indicia if deemed to be included as part of the event.

Preferably only a total of three randomly extracted balls are removed, one by one, from a ‘second’ single and separate barrel, to create the second half part of a total six number/indicia event final sequence.

Preferably thereafter, only one ball may be randomly extracted from said ‘second’ single barrel, to create the second of two supplementary numbers/indicia if included as part of the event.

Preferably said identical barrel devices employ their elements and functions in tandem concert, allowing a novel event preferred six indicia outcome that can consist of three sets of two identical numbers, with said barrel devices certainly not limited to the number of duplicate balls, held within, and not limited to the number of individual identical barrels variants employed in concert. (FIG. 6). Accordingly, producing other shorter, longer, lesser or greater sequence outcomes and the subsequent related mathematical odds of those variants, per the formula as described.

It will be appreciated by persons skilled in the art that variations and iterations may be applied to the invention, without departing from the intention, spirit, or identical duplication aspect and scope of the invention as described, with those embodiments to be considered as illustrative, and not restrictive or limiting.

The invention may also be adapted to a number of other solution applications.

Example #1 scenario of a problem solving application of the invention, comprising:

An amateur competition, like the Olympics, where prize money is not the objective, calling for two competitors at a time to compete against each other in an elimination round. Within a group of 20 competitors, the winners go into a second round, for a potential gold or silver medal, and the losers all get immediately relegated into the bronze division. No second chances. The individual competition could be fencing, badminton, or even table tennis. A team elimination could involve basketball or water polo. The issue is who plays who, in the first elimination, without regard for who the perceived ranked favourites to win, are. It's a blind selection in an immediate win or lose form of competition. Who competes against who, first up, without bias or favouritism, is the problem.

The solution: A random numbers dual identical numbers allocation according to the intent of the invention.

All twenty competitor's names or teams are subject to a dual barrel application, as per the intent of the invention. Barrel ‘A’ holds two duplicate numerical sequences from 1-10, to equal the number of competitors. In this example, twenty. Therefore, two of every number in the sequence, are held within barrel ‘A’. All the competitor names are in a second barrel, ‘B’. To ensure an absolute random and unbiased selection, preferably, both barrels are transparent, agitated in some manner, and then subjected to a visible single selection and extraction. In this example the process is undertaken twenty times.

A number, being one any of the 1-10 sequence, is randomly drawn from barrel ‘A’, and one of the names is randomly drawn from barrel ‘B’. As an example, this first drawn competitor gets the number ‘3’. A second name and number are then drawn. When another drawn competitor also gets the number ‘3’, because of the duplicate sequence numbers, they will compete against each other as a first encounter. This also creates the absolute possibility that the first and second ranked competitors will compete against each other in the very first round. It is equally possible the least ranked and the favourite compete against each other in the first round.

Each of the identical duplicated numbers would stay as removed, while each of the other remaining numbers and names are extracted, until all ten pairs have been matched.

A second round elimination would follow the same procedure with a reduced number of the winners in one division, and the other division comprised of the first round losers. The methodology allows the possibility that a complete underdog may win the overall competition, with the perceived ranked favourites knocking each other out.

The dual barrel iteration, according to the invention, eliminates the real problem of human error and bias in the process of a manual human selection, which cannot provide a true and absolute random selection. It also solves and overcomes the problem, and the reality, of manipulating an outcome to gain an advantage.

Example # Two, of a problem solving application:

In a medicinal product production line, or even a critical car component, where a company runs a facility running two separate production lines, a parity of quality control would have to be of a continuously high standard at both locations. The products would have to be exact in every way, every time. To ensure the two locations both adhere to the demanded standard, separately, a random selection from the production line from each location could be undertaken. Most likely, firstly, an individual assessment of each article for the expected quality control, would be followed by a parity comparison to each other, providing a critical quality cross check of the randomly selected pair.

With both locations running in sync, an application incorporating the duality and duplication intent according to the invention, provides a novel solution to parity quality control.

The solution: A random number generator produces a single article number to be applied to the existing dual production plant lines. As an example, a production protocol chooses to isolate one in every three thousand, at both points, to provide a valid verifiable dual checkpoint. A system in plant ‘A’ produces a random first part request to extract product article number 2110* from the production line, and syncs with a system in plant ‘B’, responding with an exact second part request, to also select article 2110*, at the same time, at the second location. A duality of intent has been created, producing a single pair for a matching parity quality inspection during the production timeline. Employing the elements of a duality random number generator, there is no actual physical involvement in allocating the duplicate number 2110*. As such, there can be no influence or bias attached to either production line during the process of the random number selection, and the two subsequently removed 2110* articles. The intention and application of the invention provides a simple practical solution to a problem of maintaining a required constant level of parity quality, either, miles apart, or running in tandem within the same facility.

### In Use

A stand-alone event in accordance with the methodology and embodiments described. In a preferred variation, the event final outcome requires the employment of two devices common to the genre, however as per the intention, identical in every way and used in tandem concert.

A duplicate/identical predetermined number of numbered balls are held within each of the device enclosures. These two identical twin but separate devices, working in tandem, using best current agitation and scrambling methods, followed by a mechanical or suction extraction technology, are so employed to randomly extract a preferred 3 only numbered balls from a first device, in tandem concert with the second device, also extracting 3 only numbered balls, to produce a final total of only 6, with a further possibly of a random two supplementary balls, one from each device, if so desired, to produce a complete, combined event result sequence, which may be comprised of, and include a pair, or pairs of, and from, the duplicate ball sequences.

1. A method of producing a desired random number outcome sequence, comprising:
providing a first, and a second, enclosed container barrel;
wherein the container barrel enclosures are transparent clear and identical to each other;
providing a number of balls, each container barrel enclosure separately holding exactly the same predetermined number of balls, and each of the balls in the first barrel being marked with a predetermined numerical sequence, and each of the balls in the second barrel being marked with the exact same numerical sequence as the first to produce a first half part and a second half part of a desired sequence of random numbers, by consecutively withdrawing, in a random manner, a preset limited number of marked balls from the first barrel enclosure, in tandem with, exactly the same preset limited number of marked balls withdrawn in a random manner from the second barrel; arranging the withdrawn balls to provide a first half part, and a second half part, and combining the first and second parts together to produce a desired single random number output sequence.

2. A method of producing a desired random number outcome sequence, according to claim 1; wherein the withdrawn balls comprise two identical sets of consecutive sequential numbers, with each of the balls in the first barrel being marked with a predetermined numerical sequence, and each of the balls in the second barrel being marked with the exact duplicate numerical sequence as the first, so as to provide for a predetermined limited number of said balls, subsequently withdrawn in a random manner from each barrel, a desired random number outcome.

3. A method of producing a desired random number outcome sequence, according to claim 2; wherein the predetermined applied numerical sequences are comprised of multiple identical sets of sequential numbers, providing for a predetermined limited number of said marked balls subsequently withdrawn from each barrel, in a random manner, to produce a desired random number outcome.

4. A method of producing a desired random number outcome sequence according to claim 1; wherein the numbered balls within the first barrel enclosure are identically marked to those in the second barrel enclosure, with each ball individually and sequentially marked with one of the following numerical sequences: 1-36, 1-39, 1-44, and 1-48, so as to provide a predetermined limited number of said marked balls subsequently withdrawn from each barrel, in a random manner, to produce a desired random number outcome.

5. A method of producing a desired random number outcome sequence according to claim 1, further comprising; injecting forced air into each of the first and the second barrel enclosures, wherein all the balls in the first and second barrels are lightweight, such that the injection of the air into the first and second barrels causes the balls therein to levitate and move randomly and freely in three dimensional space within said enclosed first and second barrels, for a predetermined period of time; and subsequent to the predetermined period of time stopping the injection of air into each barrel so that the balls therein fall randomly to the bottom of each of the enclosed first and second barrels, and withdrawing the fallen balls in a random manner until a preset limited number of marked balls are withdrawn from within the first barrel and exactly the same number of marked balls are withdrawn from within the second barrel; and combining the withdrawn balls so as to produce a desired single whole random number output sequence.

6. A method of producing a desired random number outcome sequence according to claim 3, wherein three marked balls are withdrawn from within the first barrel enclosure; a first half part is generated using the three numbers of the withdrawn balls; three marked balls withdrawn in a random manner from within the second barrel enclosure, and combining the first half part three numbers and the second half part three numbers to produce a desired whole and final six number random number sequence.

7. A method of producing a desired random number outcome sequence according to claim 3, whereby a first part numerical sequence and a second part numerical sequence, combined, have the absolute mathematical probability and physical possibility of producing a desired single whole random number output sequence, comprised of one of: three pairs; two pairs and two singles; one pair and four singles, and six singles

8. A method of producing a desired random number outcome sequence according to claim 6, wherein there are at least two identical barrel enclosures, each of the at least two barrel enclosures, containing therein a single predetermined duplicated set of numbered balls, and balls withdrawn from the at least two barrel enclosures are provided in tandem concert to produce a desired final outcome random single sequence.

9. A method of producing a desired random number outcome sequence according to claim 6, wherein withdrawn balls are utilised in tandem concert to produce a desired final outcome random single sequence, which may be comprised of one of: three pairs of indicia, two pairs and two singles, one pair and four singles, and six singles.

10. A method of producing a desired random number outcome sequence according to claim 6, further comprising: a player entry/participation card; wherein the card displays two identical numbered boxes set side by side reflecting the duplicated indicia ball sequence associated with the applied variation.

11. A method of producing a desired random number outcome sequence according to claim 6, further comprising: a player entry/participation card; wherein the card displays a single numbered box, set out in immediately adjacent pairs; reflecting the duplicated indicia ball sequence associated with the applied variation.

12. A method of producing a desired random number sequence, comprising: providing a single barrel enclosure which contains therein at least a first and second sets duplicate sequentially numbered balls; the method comprising selecting randomly a set of six numbers, comprised of one of three pairs, two pairs and two singles, one pair and four singles, and six singles, of and from, and combining the numbered ball sequences within the enclosure barrel.

13. A method of producing a desired random number sequence according to claim 1, wherein the marked balls include one of the sequence variations: 1-36, 1-39, and 1-44.
